(19) United States
(12) Patent Application Publication
(10) Pub. No.: US 2014/0025374 A1
(43) Pub. Date: Jan. 23, 2014

(54) SPEECH ENHANCEMENT TO IMPROVE SPEECH INTELLIGIBILITY AND AUTOMATIC SPEECH RECOGNITION

(71) Applicant: Xia Lou, San Ramon, CA (US)

(72) Inventor: Xia Lou, San Ramon, CA (US)

(21) Appl. No.: 13/947,079

(22) Filed: Jul. 21, 2013

Related U.S. Application Data
(60) Provisional application No. 61/674,361, filed on Jul. 22, 2012.

(51) Int. Cl. G10L 15/20

(52) U.S. Cl. CPC G10L 15/20
USPC 704/203

(57) ABSTRACT

The present invention provides a system and method to enhance speech intelligibility and improve the detection rate of automatic speech recognizer in noisy environments. The present invention reduces an acoustically coupled loudspeaker signal from a plurality of microphone signals to enhance a near end user speech signal. A decision unit checks a system configuration parameter to determine if the cleaned speech is intended for human communication and/or Automatic Speech Recognition (ASR). A formant emphasis filer and a spectrum band reconstruction unit are used to further enhance the speech quality and improve the ASR recognition rate. The present invention can also apply to devices which has a foreground microphone(s) and a background microphone(s).

### CROSS-REFERENCE TO RELATED APPLICATIONS

This application claims the benefit of U.S. Provisional Application No. 61/674,361, filed Jul. 22, 2012, which is hereby incorporated by reference in its entirety.

### STATEMENT REGARDING FEDERALLY SPONSORED RESEARCH OR DEVELOPMENT

Not Applicable

### BACKGROUND

1. Field of the Invention

The present invention relates to the speech enhancement methods and systems used to improve speech quality and the performance of Automatic Speech Recognizers (ASR) in noisy environments. It removes the unwanted noise from the near end user speech. It also emphasizes the formants of the user speech and simultaneously extracts clean speech acoustic features for the ASR to improve its recognition rate.

2. Background of the Invention

In the everyday living environments, noise is everywhere. It not only affects speech quality in mobile communications and Voice Over IP (VOIP) applications, but also severely decreases the accuracy of the Automatic Speech Recognition.

One particular example is related to the digital living room environment. The connected devices such as smart TVs or smart appliances are being widely adopted by increasing numbers of consumers. In doing so, the digital living room is evolving into the new digital hub, where Voice Over Internet Protocol communications, social gaming and voice interactions over Smart TVs become central activities. In these situations, the microphones are usually placed near the TV or conveniently integrated into the Smart TV itself. The users normally sit at a comfortable viewing distance in front of the TV. The microphones not only receive the users speech, but also pick up the unwanted sound from the TV speakers and room reverberations. Due to the close proximity of the microphone(s) to the TV loudspeakers, the users speech could be overpowered by the unwanted audio generated by the TV speakers. Inevitably this affects the speech quality in VOIP applications. In Talk Over Media (TOM) situations, when users prefer to use their voice to control and search media content while watching TV at the same time, their speech commands, coupled with the high level of unwanted TV sound would render Automatic Speech Recognition nearly impossible.

Speech enhancement has been an crucial technology to improve speech clarity and intelligibility in noisy environments. Microphone array beamformers have been used to focus and enhance the speech from the direction of the talker. It basically acts as a spatial filter. Acoustic Echo Cancellation (AEC) is another technique to filter out unwanted far end echo. If the signal produced by the TV speaker(s) is known, it can be treated as a far end reference signal. But there are several problems with the prior art speech enhancement techniques. Firstly, the prior art techniques are mainly designed for near field applications where the microphones are placed close to the talker such as in mobile phones and Bluetooth headsets. In near field applications, the Signal to Noise Ratio (SNR) is high enough for speech enhancement techniques to be effective in suppressing and removing the interfering noise and echo. However, in far field applications, the microphones could be 10 to 20 feet away from the talker. The SNR in the microphone signal, located at this distance is very low, and the traditional techniques normally would not perform very well. The results produced by the traditional methods either have large amounts of noise and echo remaining or introduce high levels of distortion to the speech signal which severely decreases its intelligibility. Secondly, the prior art techniques fail to distinguish the VOIP applications from the ASR applications. The processing outputs which is intelligible to a human may not be recognized well by an ASR. Thirdly, the prior art techniques of speech enhancement are not power efficient. In the prior art techniques, adaptive filters are used to cancel the acoustic coupling between loudspeakers and microphones. However, large number of filter taps are required to reduce the reverberant echo. The adaptive filters used in prior arts are slow to adapt to the optimum solution, and further more require significant processing power and memory space.

The current invention intends to overcome or alleviates all or part of the shortcomings in the prior art techniques.

### SUMMARY OF THE INVENTION

Accordingly, the present invention provides a system and method to enhance speech intelligibility and improve the detection rate of automatic speech recognizer in noisy environments. The present invention reduces an acoustically coupled loudspeaker signal from a plurality of microphone signals to enhance a near end user speech signal. The early reflections of the loudspeaker signal(s) is first removed by an estimation filtering unit. This estimated early reflections signal is transformed into an estimated late reflections signal which statistically closely resembles the remaining noise components within the estimation filtering unit output. A speech probability measure is also derived to indicate the amount of the near end user speech within the estimation filtering unit output. A noise reduction unit uses the estimated late reflections signal as a noise reference to remove the remaining loudspeaker signal. A decision unit, checks a system configuration parameter to determine if the cleaned speech is intended for human communication and/or Automatic Speech Recognition. The low frequency bands of the cleaned speech signal is reconstructed to enhance its naturalness and intelligibility for communication applications. In case that the ASR is enabled, the peaks and the valleys of lower formants of the cleaned speech are emphasized by a formant emphasis filter to improve the ASR recognition rate. A set of acoustic features and processing profiles are also generated for the ASR engine. The present invention can also apply to devices which has a foreground microphone(s) and a background microphone(s).

### BRIEF DESCRIPTION OF THE DRAWINGS

FIG. 1 is a system function block diagram of a Smart TV application in which the present invention may be applied.

FIG. 2 illustrates a functional block diagram of a speech enhancement processing unit used in talk over media applications depicted in FIG. 1.

FIG. 3 illustrates a detailed flow diagram of a speech enhancement processing unit used to enhance speech quality and improve the detection rate of the Automatic Speech Recognizer.

FIG. 4 is an exemplary embodiment of an adaptive estimation filtering unit, which is shown as block 307 in FIG. 3.

FIG. 5 shows an embodiment of the noise transformation unit as illustrated in block 308 of FIG. 3.

FIG. 6 is an exemplary embodiment of a noise suppression unit, which is shown as block 311 in FIG. 3.

FIG. 7 illustrates an exemplary embodiment of a formant emphasis filter, which is shown as block 315 in FIG. 3.

FIG. 8 is an exemplary mobile phone system to illustrate the use of the present invention.

FIG. 9 illustrates an example of a general computing system environment.

### DETAILED DESCRIPTION OF ILLUSTRATIVE EMBODIMENTS

### Overview

Embodiments of the present invention not only improve the speech intelligibility, but also simultaneously provide suitable features to improve the recognition rate of the ASR.

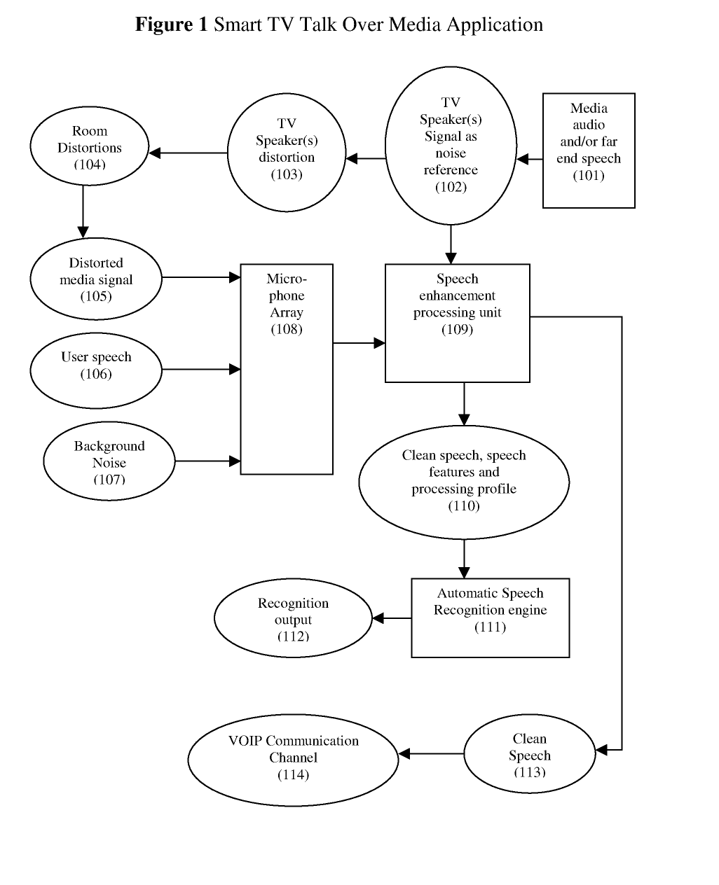

FIG. 1 is a system function block diagram in a Smart TV talk over media

(TOM) application to which the present invention may be applied. New Smart TV services integrate traditional cable TV offerings with other internet functionality which were previously offered through a computer. Users can browse the internet, watch streaming videos and make VOIP calls on their big screen TV. The large display format and high definition of the TV makes it ideal for playing internet gaming or performing video chat. Smart TVs will function as the infotainment hub for the future digital living room environment. However, complicated user menu system make the TV remote an inadequate control device. Voice control is more natural, convenient, efficient and is highly desirable. In the case where the microphone(s) are integrated into or placed near the TV set, VOIP call quality can be adversely affected due to the large separation distance between the user and the microphone(s). The distance can greatly decrease the SNR levels for the received speech which can render the ASR ineffective. This problem is even more acute when the media audio is simultaneously playing through the loudspeakers. As depicted in FIG. 1 for a living room environment, the signal received by the microphone or microphone array 108 mainly comprises of the user speech signal 106, distorted media audio 105 (also known as the acoustically coupled speaker signal) and background noise 107. The acoustic path between the TV speakers and the microphone array 108 introduces acoustic distortions to the received TV speaker signal 102. The majority of these distortions are related to the room impulse response and the loudspeakers frequency response. In order to separate the user speech signal from the distorted media audio, the TV speaker signal 102 is utilized as a noise reference for the speech enhancement processing unit 109. The cleaned speech signal is obtained by separating the media sound from the received microphone(s) signal. The cleaned speech signal is input to the other functions such as compression or for transmission over VOIP channels 114 as needed. If the application is using ASR, a set of acoustic features suitable for the ASR is generated from the cleaned up speech signal after the speech enhancement unit. The acoustic feature set could be Mel-frequency cepstrum coefficients (MFCC) based. It may also be Perceptual Linear Prediction (PLP) coefficients or some other custom feature set. A set of processing profiles and statistics acting as priory information are also generated and combined with the acoustic features for the ASR acoustic feature pattern matching engine 111.

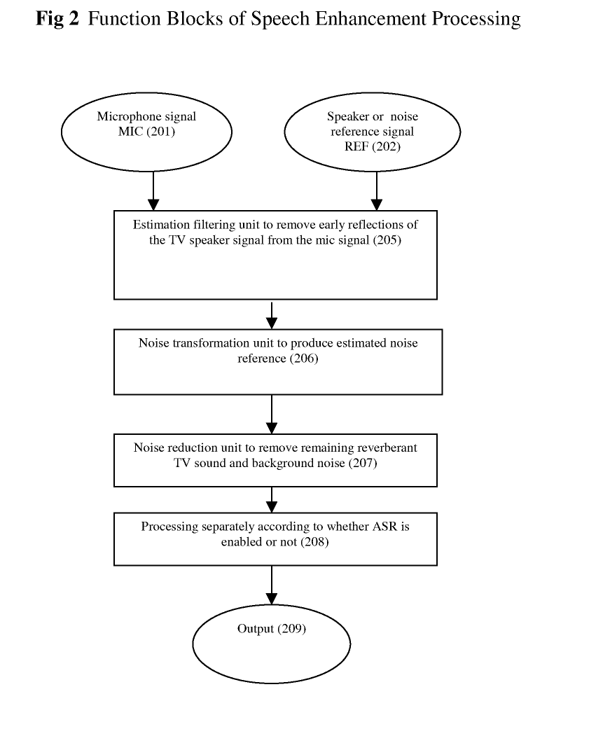

FIG. 2 illustrates a function block diagram of a speech enhancement processing method used in a talk over media application depicted in the FIG. 1. The present invention uses a multi-stage approach to remove the unwanted TV sound and background noise from the microphone signal 201. In a living room environment, the microphone signal contains user speech, a distorted speaker signal and background noise. Due to the multi-path acoustic nature of the room, the distorted speaker signal can be represented by the summation of the early reflections and the late reflections. The present invention uses an estimation filtering unit 205 to remove the early reflections of the speaker signal. The early reflection time in a room typically ranges from 50 milliseconds to 80 milliseconds. The estimation filter need only estimate the first 80 milliseconds of the room impulse response or the room transfer function. Thus the estimation filter in the present invention only requires a reduced number of filter taps. The reduced number of filter taps not only enables the filter to converge faster to the optimum solution in the initial phase, but also makes the filter less prone to perturbations of the acoustic path changes. In comparison to the prior art techniques, traditional acoustic echo cancellation requires much larger filters to adapt to the full length of a room impulse response, which normally exceeds 200 milliseconds. The large number of filter taps for the adaptive filter leads to increased memory and power consumption. The estimation filter outputs are used by the noise transformation unit 206 to produce an estimated late reflections signal as a noise reference signal. The noise reference signal closely resembles the late reflections of the distorted speaker signal. The noise reference signal is used by the noise reduction unit 207 to further remove the reverberant late reflections and possibly the background noise. Afterwards, the present invention uses different methods to further process the signal according to whether the ASR is enabled or not.

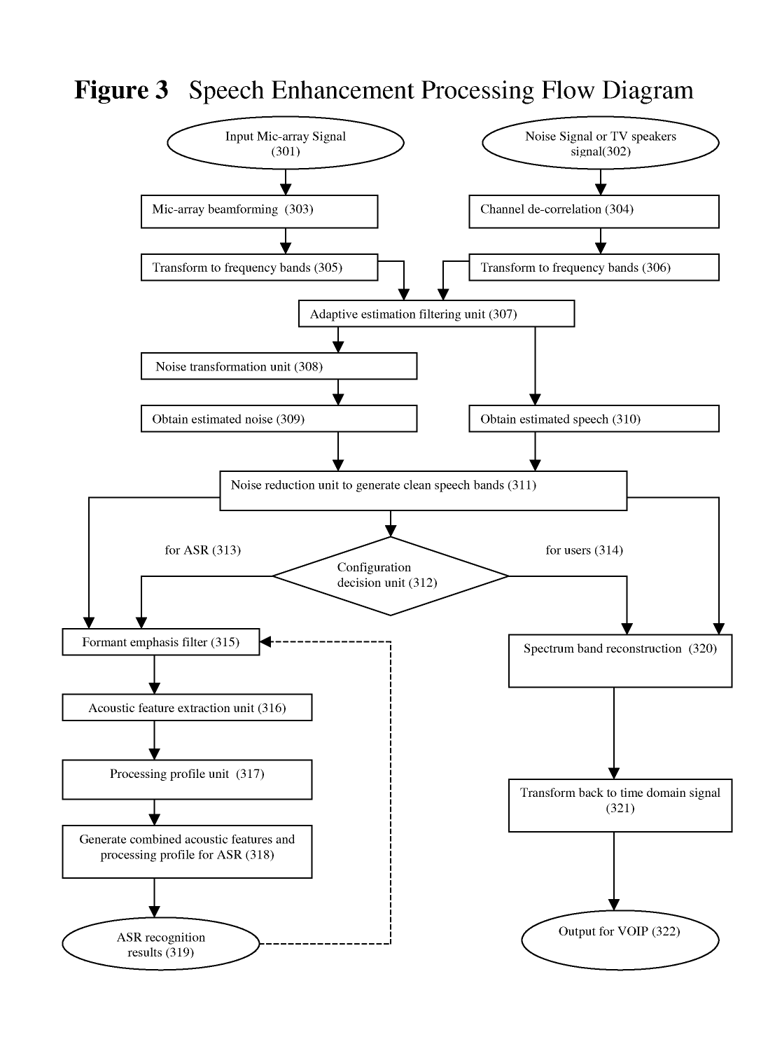

FIG. 3 illustrates a detailed flow diagram of the speech enhancement processing unit, which enhances speech quality and improves the detection rate of the Automatic Speech Recognizer. In one embodiment, a microphone array 301 comprises of two omni directional microphones. A different number of microphones with various geometric placements may be adopted in other embodiments. Beamforming processing 303 is used to localize and enhance the near end user speech signal in the direction of the talker. In one embodiment, Mininum Variance Distortionless Response (MVDR) beamforming can be used to generate a single microphone beamforming output signal. In another embodiment, Linearly Constrained Minimum Variance beamforming techniques can be employed. In yet another embodiment where the position of the talker is known, a set of weighting coefficients can be pre-calculated to steer the array to the known talker's position. In this case, the output of the beamformer can be obtained as the weighted sum of all the microphone signals in the array.

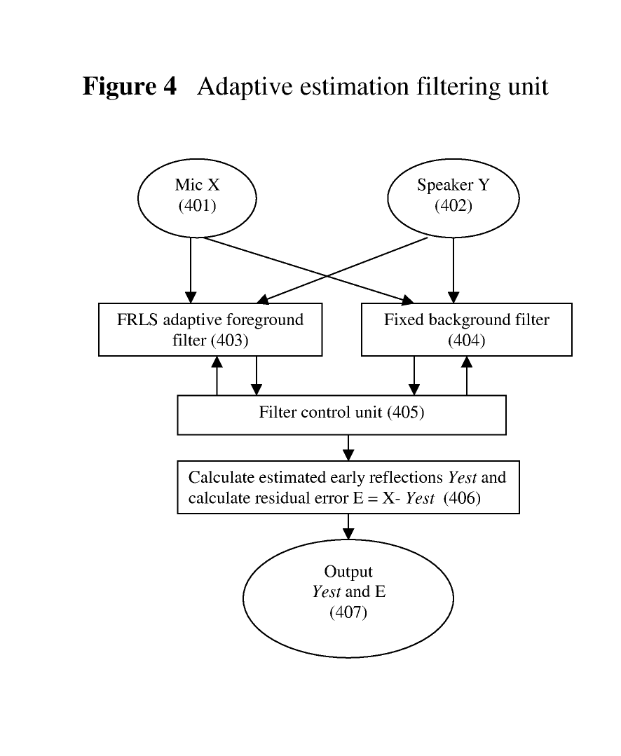

The speaker signal from the TV is normally in stereo format. There are high degree of correlation between the left channel and the right channel. This inter channel correlation will increase the difficulty for the estimation filter to converge to the true optimum solution. In FIG. 4, a channel de-correlation unit 304 is employed. In one embodiment, de-correlation is achieved by adding inaudible noise to both channels. In another embodiment, a half wave rectifier is used to de-correlate the left and right channels. In another embodiment, where the talker's position is known, the pre-calculated microphone array beamforming weighting coefficients can be applied as the channel mixing weight coefficients to derive a single channel output from the de-correlation unit.

The method in the present invention can be implemented in time domain or frequency domain. Signal processing in the frequency domain is generally more efficient than processing in the time domain. In case of a frequency domain implementation, the microphone signal and the speaker signal are transformed into frequency coefficients or frequency bands as depicted by block 305 and 306. Filter banks such as Quadrature Mirror Filter (QMF) and Modified Discrete Cosine Transform (MDCT) can be used to implement the time domain to frequency domain transformation. In one embodiment, time domain to frequency domain transformation is done using a short time Fast Fourier Transform (FFT). First, the signal in the time domain are segmented into overlapping frames. The overlapping ratio may be 0.5. A sliding analysis window is applied to each overlapping frame. The sliding analysis window may be a Hamming window, a Hanning window or a Cosine window. Other windows are also possible. Each windowed overlapping frame is transformed into the frequency domain by an FFT operation. The output of the FFT can further be transformed into a suitable human psycho-acoustical scale such as Bark scale or Mel scale. A logarithmic operation may be further applied to the magnitude of the transformed frequency bands.

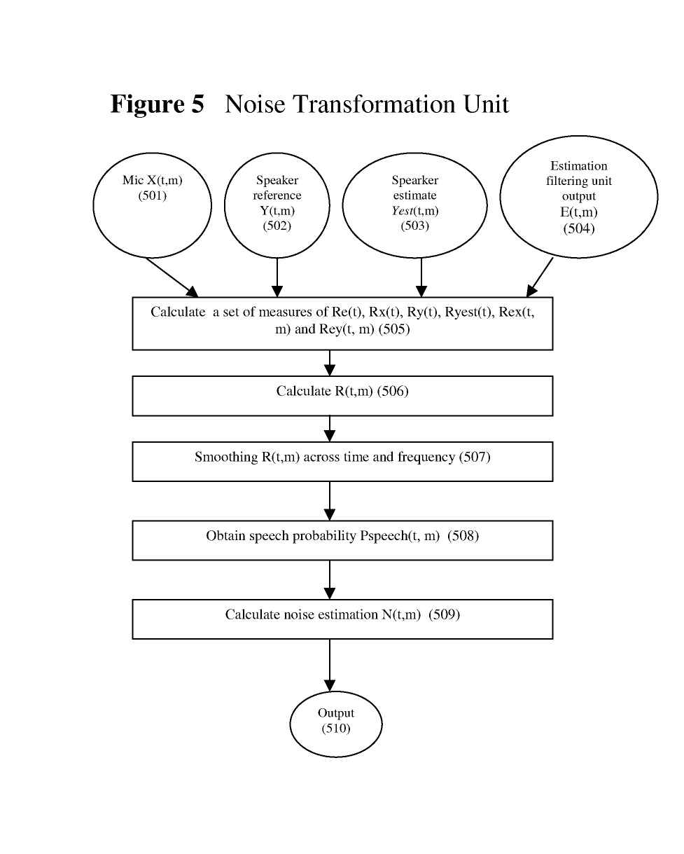

An estimation filtering unit 307 is used to estimate and remove the early reflections of the speaker signal. In one embodiment, the estimation filter can be implemented as a FIR filter with fixed filter coefficients. The fixed filter coefficients may be derived from the measurements of the room. In another embodiment, an adaptive filter can be used to estimate the early reflections of the speaker signal. A detailed embodiment of an adaptive estimation filtering unit can be found in FIG. 5.

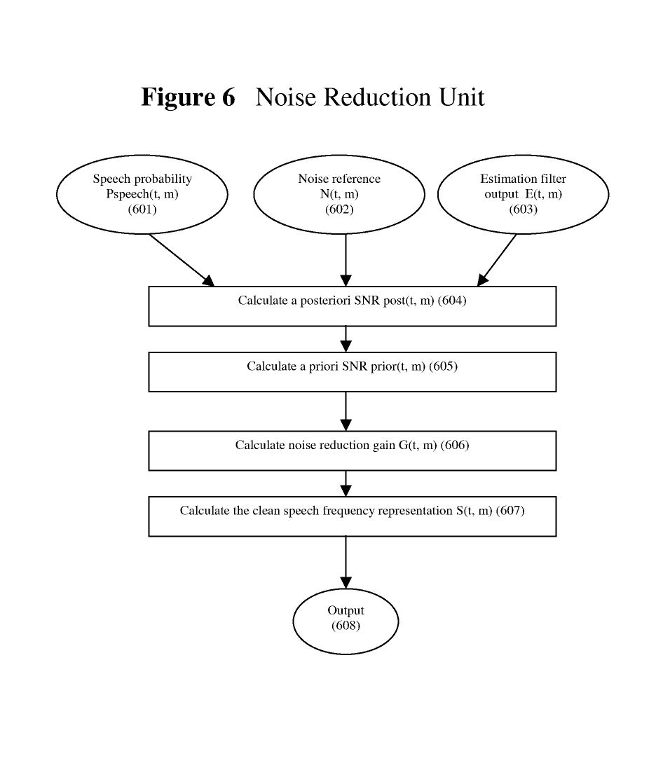

The estimation filtering unit removes the early reflections of the speaker signal. The output of the estimation filtering unit consists of the user speech signal with a certain amount of residual noise, which is largely caused by the late reflection of the speaker signal. The noise transformation unit uses the estimated early reflections of the speaker signal from the estimation filtering unit to derive a representation of the late reflections of the speaker signal. The goal is to generate a noise reference that is statistically similar to the noise component which remains in the output of the estimation filtering unit. The noise transform unit also generates a plurality of speech probability measure Pspeech(t, m) to indicate the amount of near end user speech signal present in the estimated early reflections signal, where t represents the t-th frame and m represents the m-th frequency band. A detailed embodiment of a noise transformation unit is represented in FIG. 6.

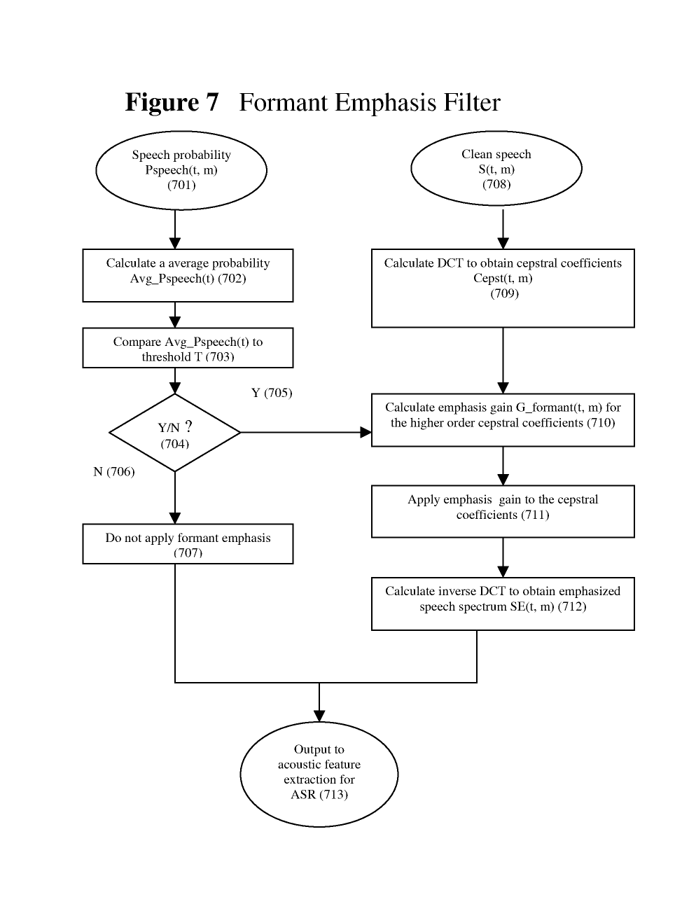

Noise reduction unit 311 is used to further reduce late reflection components from the speech bands. An exemplary embodiment can be found in FIG. 7.

A configuration decision unit 312 is used to control the processing into two branches according to a system configuration parameter. In one embodiment, only one of the two branches is processed. In another embodiment, both branches are processed. One processing branch 314 is aimed to improve speech quality for human listener. The other processing branch 313 focuses on improving the recognition rate of the ASR. In order to adequately suppress noise, the noise reduction unit 311 may remove a significant amount of low frequency content from the speech signal. Thus, the speech signal sounds thin and unnatural when the bass components are lost. In the speech enhancement branch 314 for human listeners, spectrum content analysis is performed and lower frequency bands can be reconstructed 320. In one embodiment, Blind Bandwidth Extension is used to reconstruct the bass part of the speech spectrum. In another embodiment, the Pspeech(t, m) generated by the noise transformation unit 308 is compared to a threshold to generate a binary decision. An exemplary value for the threshold may be 0.5. The binary decision is used to determine whether to reconstruct the t-th frame and the m-th frequency band. In yet another embodiment, the reconstructed low frequency bands after Blind Bandwidth Extension are multiplied with the corresponding Pspeech(t, m) to generate a new set of reconstructed speech bands. This new set of reconstructed speech bands are transformed back to time domain to be transmitted to the VOIP channels. In one exemplary embodiment, the transformation from frequency domain to time domain can be implemented using Inverse Fast Fourier Transform (IFFT). In other embodiments, filter banks reconstruction techniques can be utilized.

In the processing branch for ASR 313, a formant emphasis filter 315 is used to emphasize the spectrum peak of the cleaned speech while maintaining the spectrum integrity of the signal. It can improve the Word Error Rate (WER) and confidence score of the ASR engine. One embodiment of the emphasis filter is illustrated in the FIG. 7. Afterwards, certain acoustic features such as MFCC, PLP coefficients are extracted from the emphasized speech spectrum 316. A processing profile is produced in block 317, which may comprise of a speech activity indicator and a speech probability indicator for each frequency band. The processing profile may be coded as side information. The processing profile may also contain statistical information such as the mean, variance and derivatives of the spectrogram of the cleaned speech. The profile together with the acoustic features can make up the combined features, which are used to help the ASR achieve better acoustic feature matching results. Optionally, the matched results and confidence scores from the pattern matching engine of the ASR may be fed back to the formant emphasis filter to refine the filtering process.

FIG. 4 is an example of an adaptive estimation filtering unit 307 which is shown in FIG. 3. A foreground adaptive filter 403 and a fixed background filter 404 are used. The foreground adaptive filter 403 may be implemented in the time domain, the frequency domain or other suitable signal space. In one embodiment, the foreground adaptive filter coefficients may be updated according to Fast Least Mean Square (FLMS) method. In another embodiment, a Frequency Domain Adaptive (FDA) filter is used. In yet another embodiment, Fast Recursive Lease Square (FRLS) filter is used. Other adaptive filter techniques such as Fast Affine Projection (FAP) and Voterra filter are also suitable. The fixed background filter stores the setting of the last foreground adaptive filter if it was stable. The estimated early reflection Yest can be obtained from the output of one of the filters determined by the filter control unit 405. The filter control unit 405 chooses which filter to use based on the residual value E, where E is the difference between the microphone signal X and the estimated early reflection of speaker signal Yest. The results can be expressed as E=X−Yest. In case that the fixed background filter output is selected, the fixed background filter settings is copied back to the adaptive foreground filter. In case that a near end user speech signal is present in the microphone signal X, the filter control unit 405 decreases or freezes the adaptation rate of the adaptive foreground filter to minimize filter divergence.

FIG. 5 shows an embodiment of the noise transformation unit as in the block 308 of the FIG. 3. One embodiment of the present invention transforms the input microphone signal and the speaker signal into the frequency domain. The time domain signal of the microphone and the speaker are segmented into overlapping sequential frames. The overlapping ratio can be 0.5. A sliding analysis window is applied to the sequential overlapped frames. A FFT operation is applied to the windowed frames to obtain a set of FFT coefficients in the frequency domain. The FFT coefficients may be combined into different frequency bands according to Mel scale or Bark scale in logarithmic spacing. The logarithmic operation may further be applied to the absolute value of each frequency bands. The frequency domain representation of the microphone signal 501 for a plurality of sequential frames may be saved in a matrix form. Each element of the matrix, noted as X(t, m), represents the t-th frame in time and m-th band in frequency. Similarly, the frequency representation of the speaker signal 502 is noted as Y(t, m). The frequency representation of the estimated early reflections 503 is noted as Yest(t, m). The frequency representation of the estimation filtering unit output 504 is noted as E(t, m).

When the near end user speech signal is absent from the microphone signal, the signal E(t, m) contains mostly the late reflections of the signal Y(t, m); the signal E(t, m) is highly correlated to Y(t, m); the signal Yest(t, m) approaches to the true estimate of the early reflections of Y(t, m). Alternatively, when the near end user speech is present in the microphone signal, E(t, m) contains the late reflections of Y(t, m) and the near end user speech; E(t, m) is less correlated to Y(t, m). Due to the nature of the adaptation processes used in the estimation filtering unit 307, Yest(t, m) contains the mix of the early reflections estimation and a small portion of near end user speech signal. A speech probability measure Pspeech(t, m) is used to indicate the amount of presence of near end user speech within Yest(t, m). Both Yest(t, m) and Pspeech(t, m) are used in block 509 to derive the estimated noise N(t, m). In one embodiment of the present invention, a set of measures are calculated in block 505. The measures Re(t), Rx(t), Ry(t) and Ryest(t) represent the spectrum energy of E, X, Y and Yest at a given time. Rex(t, m) is the cross correlation between E and X of the t-th frame and the m-th frequency band. Rey(t, m) is the cross correlation between E and Y of the t-th frame and the m-th frequency band. Block 506 calculates the ratio R(t,m). The value of R is proportional to the value of Re and inversely proportional to the Rey. The value of is also inversely proportional to the difference between Rx and Ryest. In one embodiment, R(t,m) is a multiplication of several terms, which can be expressed as follows,

R(t, m)=1/((Rey(t, m)/Ry(t))*(Rex(t, m)/Rx(t))*Ryest(t)/Re(t)))

In another embodiment, R(t, m) can be calculated recursively as,

R(t, m)=alpha_{—}R*R(t−1, m)+(1-alpha_{—}R)/((Rey/Ry)*(Rex/Ry)*(Ryest/(Rx-Ryest)))

where alpha_R is a smoothing constant, 0<alpha_R<1.

In yet another embodiment, R(t, m) is calculated using different equations depending on different values of Rx(t), Ry(t), Ryest(t) and different convergence states of the adaptive filter 403 . The Pspeech(t, m) can be obtained by smoothing R(t, m) across several time frames and across several adjacent frequency bands. In one embodiment, a moving average filter can be used to achieve the smoothing effects. In another embodiment, the measures Re, Rx, Ry, Ryest, Rex and Rey can be smoothed across time frames and frequency bands before calculating the ratio R(t, m).

In the block 509, The noise estimation N(t, m) may be obtained as a weighted sum of the Yest(t, m) and a function of prior Yest values, which can be expressed as:

N(t, m)=(1−Pspeech(t, m))*Yest(t, m)+F[ (1−Pspeech(t−i, j)*Yest(t−i, j)];

where i<t ; 1<j <max number of bands ; F[ ] is a function.

In one embodiment, F[ ] can be a weighted linear combination of the previous elements in Yest. Since the late reflections energy decays exponentially, the i term can be limited to the frames within the first 100 milliseconds of the current frame. In one embodiment, the weight used in the linear combination may be the same across all previous elements in Yest. In another embodiment, the weight used in the linear combination decrease exponentially, where the newer elements of Yest receives larger weight than the older elements. In another embodiment, N(t, m) may be derived recursively as follows,

A(1,m)=P(1, m)*Yest(1, m);

B(1, m)=P(1, m)*Yest(1, m)−Yest(0, m);

A(t−1, m)=beta1*P(t−1,m)*Yest(t−1, m)+(1−beta1)*(A(t−2, m)−B(t−2, m));

B(t−1, m)=beta2*(A(t−1, m)−A(t−2, m))+(1−beta2)*B(t−2, m);

N(t, m)=P(t, m)*Yest(t, m)+P(t−1, m)*C_decay*(A(t−1, m)+B(t−1,m));

where P(t, m)=1−Pspeech(t, m);

beta1 is a constant, beta1 is within the range of 0.0 to 1.0;

beta2 is a constant, beta2 is within the range of 0.0 to 1.0;

C_decay is a constant, C_decay is within the range of 0.0 to 1.0.

FIG. 6 is an exemplary embodiment of a noise reduction unit which is shown as block 311 in FIG. 3. The noise reduction unit utilizes the estimated noise N(t, m) and the speech probability Pspeech(t, m) to further suppress noisy components in the signal E. E is the output signal produced by the adaptive estimation filtering unit. The present invention can achieve better noise suppression effects than prior arts because N closely represents the noisy components in E and can be used as a true reference. The noise reduction procedure used to generate the cleaned speech signal S can be illustrated as follows,

1) calculate a posteriori SNR post(t, m),

post(t,m)=power[E(t, m)]/Var_{—}N(t, m)
where power[E(t, m)] is the power of the E(t, m),
   Var_N is the variance of N(t, m);

2) calculate a priori SNR prior(t,m),

prior(t, m)=a*S(t−1, m)/Var_{—}N(t−1, m)+(1−a)*P[post(t, m)−1]
where a is a smoothing constant, 0<a<1,
   P[ ] is an operator; if x>=0, P[x]=x ; if x<0, P[x]=0;

3) calculate a ratio U(t, m);

U(t, m)=prior(t, m)*post(t, m)/(1+prior(t, m))

4) calculate a Minimum Mean Squared Error(MMSE) estimator gain Gm(t, m)

Gm(t, m)=(sqrt(PI)/2)*(sqrt(U(t, m)*post(t, m))*exp(−U(t,m)/2) *((1+U(t, m))*I0[U(t,m)/2)]+U(t, m)*I1[U(t,m)/2])
where sqrt is square root operator, PI=3.14159,
   exp is exponential function,
   I0[ ] is the zero order modified Bessel function,
   I1[ ] is the first order modified Bessel function.

5) calculate the noise reduction gain G(t, m);

G(t,m)=Pspeech(t, m)*Gm(t, m)+(1−Pspeech(t, m)*Gmin
where Gmin is a constant, 0<Gmin<1.

6) apply the noise reduction gain G(t, m) to E(t, m) to obtain the cleaned speech

S(t, m);

S(t, m)=G(t, m)* E(t, m);

In one embodiment, the Weiner filter gain is used in the 4-th step of the above procedure to derive the noise reduction gain. In another embodiment, Log-Spectral Amplitude (LSA) estimator is used in the 4-th step. In yet another embodiment, Optimal Modified LSA (OM-LSA) estimator is used in the 4-th step.

FIG. 7 illustrates an exemplary embodiment of a formant emphasis filter which is shown as block 315 in FIG. 3. At first, the average probability Avg_Pspeech(t) for the t-th frame is calculated from the speech probability Pspeech(t, m). Avg_Pspeech(t) is a weighted sum of Pspeech(t, m) across all frequency bands. In one embodiment, all elements across all the frequency bands are weighted equally. In another embodiment, the speech bands within 300 Hz to 4000 Hz receive larger weights. The Avg_Pspeech(t) is compared to a threshold T, where T may be 0.5. If Avg_Pspeech(t) is less than the threshold T, the t-th frame is likely to be a non-speech frame and thus does not need to be emphasized. In the case that the Avg_Pspeech(t) is larger than the threshold, the t-th frame is likely to contain a user speech signal. The Pspeech(t, m) is used to adjust the gain of the formant emphasis filter. One embodiment of the present invention calculates the cepstral coefficients based on the cleaned speech S(t, m). The cepstral coefficients Cepst(t, m) can be derived by Discrete Cosine Transform (DCT). The cepstral coefficients are then multiplied by a gain matrix G_formant(t, m), where the gain value is proportional to the value of Pspeech(t, m). In one embodiment, G_formant(t, m) can be expressed as,

G_formant(t, m)=Kconst*Pspeech(t, m)/Pspeech_max(t);

where Kconst is a constant number and Kconst>1.0; Pspeech_max(t) is the max value of the t-th frame across different frequency bands. In one embodiment, the gain G_formant(t, m) is applied to part of the cepstral coefficients. The zero order and the first order of the cepstral coefficients are not gain adjusted to preserve the spectrum tilt. The cepstral coefficients beyond the 30^{th} order are unaltered, as those coefficients do not significantly change the formant spectrum shape. The new cepstral coefficients are then transformed back to the frequency domain by the Inverse Discrete Cosine Transform (IDCT). The resulting new speech spectrum SE(t, m) has higher formant peaks and lower formant valleys, which can improve the ASR recognition rate.

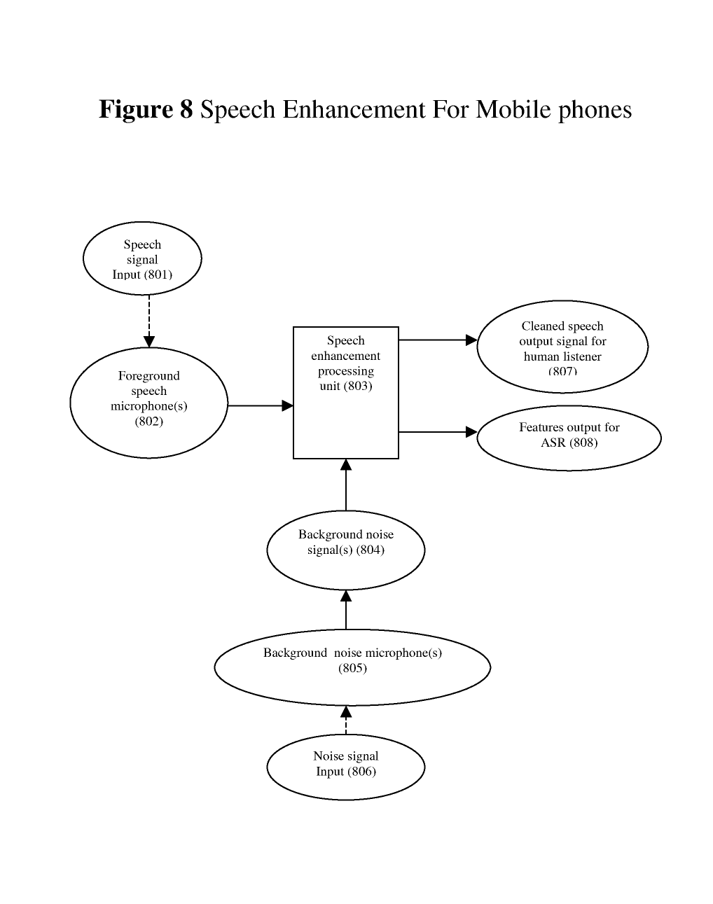

FIG. 8 is an exemplary mobile phone application to illustrate the use of the present invention. One microphone or microphone array on the phone is pointed to the talker, which is termed as the foreground speech microphone(s) 802. The other microphone or microphone array, which is termed as the background noise microphone(s) 805, may be located at the opposite end of the device from 802 and is pointed away from the talker. The signal received at the foreground speech microphone(s) 802 mainly comprises of the user speech signal and the background noise. The background noise microphone 805 signal comprises of mostly background noise signal. The noise microphone signal can be the input signal, which is shown as block 302 of FIG. 3. A speech enhancement processing unit 803 according to the present invention is used to remove the background noise from the foreground speech microphone signal. The detailed flow diagram of the speech enhancement unit is shown in FIG. 3. In this case, the early reflections signal Yest in the adaptive estimation filtering unit 307 represents the early arrival sounds from the location of the background noise microphone(s) 805 to the location of the foreground speech microphone(s) 802. In other words, the early reflections signal Yest represents an estimation of the direct acoustic propagation path between the two locations. All the processing blocks illustrated in FIG. 3 are applicable. The cleaned speech output signal 807 can be coded and transmitted to the far end talker. If the ASR is enabled, a new set of processing profiles are generated together with the ASR acoustic features such as MFCC and PLP. The combined features 808 are presented to the ASR for pattern matching in its acoustic model database.

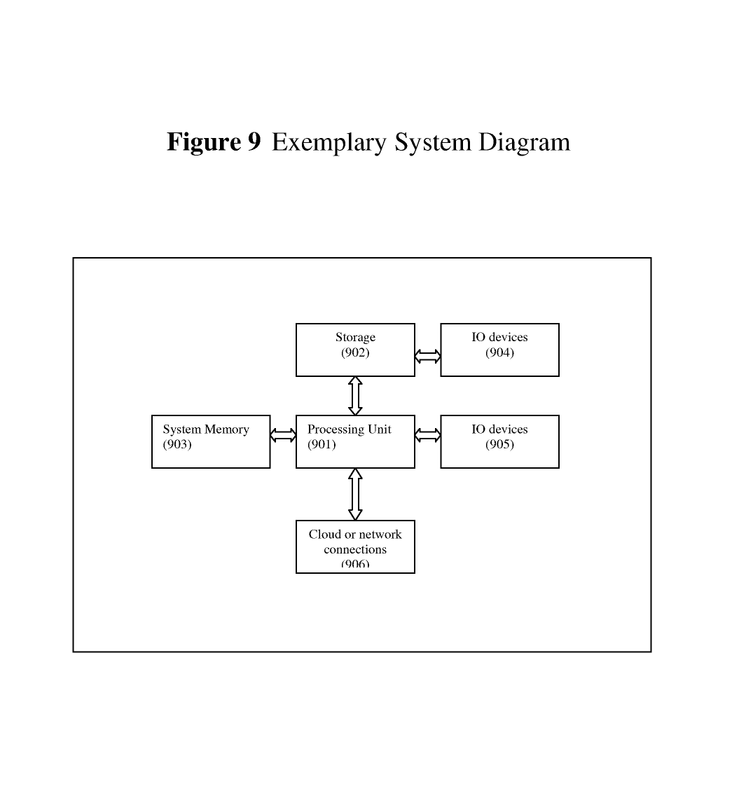

FIG. 9 illustrates an example of a general computing system environment. The computing system environment serves as an example, and is not intended to suggest any limitation to the scope of use or functionality of the present invention. The computing environment should not be interpreted as having any dependency or requirement relating to any one or combination of components illustrated in the exemplary operating environment. The illustrated system in FIG. 9 consists of a processing unit 901, a storage unit 902, a memory unit 903, several input and output devices 904 and 905, and cloud/network connections. The processing unit 901 could be a Central Processing Unit, Digital Signal Processor, Graphical Processing Unit, a computer, etc. It can be single core or multi core. The system memory unit 903 may be volatile (such as RAM), non-volatile (such as ROM, flash memory, etc.) or some combination of the two. The storage unit 902 may be removable and/or non-removable, such as magnetic or optical disks or tape. Both memory 903 and storage 902 are storage media where computer readable instructions, data structures, program modules or other data can be stored. Both 903 and 902 can be computer readable medium. Other storage can also be included in the system to carry out the current invention. This includes, but is not limited to RAM, ROM, EEPROM, flash memory or other memory technology, CD-ROM, digital versatile disks (DVD), or other magnetic storage devices or any other medium which can be used to store the desired information and which can accessed by device 900. The I/O devices 904 and 905 can be microphone or microphone arrays, speakers, keyboard, mouse, camera, pen, voice input device and etc. Computer readable instructions and input/output signals according to the current invention can also be transported to and from the network connection 906. The network can be optical, wired or wireless. The computer program implemented according to the current invention can be executed in an distributed computing by remote processing devices connected through a network. The computer program include routines, objects, components, data structures, etc.

The foregoing description of the embodiments of the invention had been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

What is claimed:

1. A system for enhancing speech quality and improving ASR performance from a plurality of microphone signals, wherein the plurality microphone signals contain a near end speech signal and an acoustically coupled loudspeaker signal, the system comprising:
a microphone array beamforming unit that generates a microphone signal which enhances the signal from the direction of the near end speech signal;
an estimation filtering unit that generates an estimated early reflections signal of the loudspeaker signal and removes the said estimated early reflections signal from the microphone signal to produce an estimation filter output signal;
a noise transformation unit that transforms the estimated early reflections signal to a late reflections signal, produces an estimated noise reference and generates a speech probability measure, the speech probability measure herein indicates the amount of the near end speech signal within the estimation filter output signal;
a noise reduction unit that generates a cleaned speech signal by suppressing the loudspeaker signal from the estimation filter output signal according to the estimated noise reference and the speech probability measure;
a decision unit that determines whether ASR is enabled.

2. The system according to claim 1, further comprising:
a formant emphasis filter that emphasizes formants spectrum peaks and valleys of the cleaned speech signal, wherein an emphasis gain is proportional to the speech probability measure;
an acoustic feature extraction unit that extracts a set of acoustic features, the set of acoustic features herein consists of Mel-Frequency Cepstral Coefficients and Perceptual Prediction Linear Coefficients;
a processing profile unit that generates a set of processing profiles, wherein the set of the processing profile consists of the speech probability measure, a plurality of means, variances and derivatives of the spectrogram of the cleaned speech signal; and
a spectrum band reconstruction unit that reconstructs low frequency bands of the cleaned speech signal, wherein the spectrum band reconstruction is determined by the speech probability measure.

3. The system according to claim 1, wherein the beamforming unit is one of (i) a Minimum Variance Distortionless Response beamformer, or (ii) a Linearly Constrained Minimum Variance beamformer.

4. The system according to claim 1, wherein the estimation filtering unit further comprising:
an adaptive foreground filter that adaptively estimates the early reflections signal;
a fixed background filter that stores the last stable setting of the adaptive foreground filter; and
a filter control unit that controls a adaptation rate of the adaptive foreground filter and selects a smaller residual error output between the adaptive foreground filter and the fixed background filter.

5. The system according to claim 1, wherein the late reflections signal is a linear combination of a plurality of early reflections signal.

6. A method for enhancing speech quality and improving ASR performance from a plurality of microphone signals, wherein the plurality microphone signals contain a near end speech signal and an acoustically coupled loudspeaker signal, the method comprising:
generating a microphone signal from the plurality of microphone signals, the microphone signal herein is a beamforming output and enhances the near end speech signal;
transforming the microphone signal and the speaker signal into frequency representation;
calculating an estimated early reflections signal of the speaker signal using an adaptive foreground filter and a fixed background filter, wherein the adaptive foreground filter length is less or equal to the length of the early reflections signal, wherein the fixed background filter stores the last stable setting of the adaptive foreground filter;
calculating a filter output signal E, the filter output signal E herein is the difference between the microphone signal and the estimated early reflections signal;
generating a speech probability measure, the speech probability measure herein indicated the amount of the near end speech signal within the filter output signal E;
transforming the estimated early reflections signal into a late reflections signal N, the late reflections signal herein is a linear function of a plurality of sequential early reflections, wherein the linear function is a recursive function;
calculating a plurality of noise reduction gains for each of the frequency band of the filter output signal E, wherein the noise reduction gain is proportional to the speech probability;
multiplying the plurality of gains with E to generate a cleaned speech signal;
determining whether Automatic Speech Recognition is enabled;

7. The method according to claim 6, wherein the Automatic Speech Recognition is enabled, the method further comprising:
emphasizing formants spectrum peaks and valleys of the cleaned speech signal to generate an emphasized speech signal, wherein the emphasis gain is proportional to the speech probability;
extracting a plurality of acoustic features from the emphasized speech signal, the set of acoustic features herein consists of Mel-Frequency Cepstral Coefficients and Perceptual Prediction Linear Coefficients; and
generating a plurality of processing profiles, wherein the plurality of processing profiles consists of the speech probability measure, a plurality of means, variances and derivatives of the spectrogram of the cleaned speech.

8. The method according to claim 6, wherein the Automatic Speech Recognition is not enabled, the method further comprising:
reconstructing low frequency bands of the cleaned speech signal spectrum to obtain a reconstructed speech signal spectrum, wherein the reconstruction is determined by the speech probability measure; and
transforming the reconstructed speech signal back to time domain.

9. The method according to claim 6, wherein the beamforming is (i) Minimum Variance Distortionless Response beamforming method, or (ii) a Linearly Constrained Minimum Variance beamforming method.

10. The method according to claim 6, wherein calculating a plurality of gains for each of the frequency bands of the filter output signal E, the said calculating further comprising:
calculating a posteriori Signal to Noise Ratio between the signal E and the late reflections signal N;
calculating a priori Signal to Noise Ratio between the signal E and the late reflections signal N;
calculating a plurality of gains with Minimum Mean Square Error short-time spectral amplitude estimator; and
obtaining a plurality of noise reduction gains by multiplying the said above gains with the speech probability.

11. The method according to claim 7, wherein the said emphasizing further comprising:
converting the cleaned speech spectrum into cepstral coefficients by Discrete Cosine Transform;
calculating a plurality of emphasis gains which is proportional to the speech probability and applying the gains to the cepstral coefficients; and
converting cepstral coefficients back to frequency domain by Inverse Discrete Cosine Transform.

12. The method according to claim 8, wherein the said reconstructed speech signal spectrum is further multiplied by its corresponding speech probability before transforming back to time domain.

13. A general purpose computing device with computer readable medium to execute a computer program according to the method in claim 6.

14. A system for suppressing a background noise from a microphone signal to improve speech quality and performance of ASR, said system comprising a foreground speech microphone unit, a background noise microphone unit and a speech enhancement processing unit, wherein the said speech enhancement processing unit comprising:
a microphone array beamforming unit that generates a foreground microphone signal which enhances a signal from the direction of a near end speech signal;
an estimation filtering unit that generates an estimated early reflections signal of the background noise microphone signal and removes the said estimated early reflections signal from the foreground microphone signal to produce an estimation filter output signal, wherein the said early reflections signal is the direct acoustic signal propagation from the location of the background noise microphone to the location of the foreground speech microphone unit ;
a noise transformation unit that transforms the estimated early reflections signal to a late reflections signal to produce an estimated noise reference and generates a speech probability measure, the speech probability measure herein represents the amount of the near end speech signal within the estimation filter output signal;
a noise reduction unit that generates a cleaned speech signal by suppressing the background noise signal from the estimation filter output signal according to the estimated noise reference and the speech probability measure;
a decision unit that determines whether ASR is enabled;

15. The system according to claim 14, further comprising:
a formant emphasis filter that emphasizes formants spectrum peaks and valleys of the cleaned speech signal, wherein an emphasis gain is proportional to the speech probability measure;
an acoustic feature extraction unit that extracts a set of acoustic features, the set of acoustic features herein consists of Mel-Frequency Cepstral Coefficients and Perceptual Prediction Linear Coefficients;
a processing profile unit that generates a set of processing profiles, wherein the set of the processing profile consists of the speech probability measure, a plurality of means, variances and derivatives of the spectrogram of the cleaned speech; and
a spectrum band reconstruction unit that reconstructs low frequency bands of the cleaned speech signal, wherein the reconstruction is determined by the speech probability measure.

16. The system according to claim 14, wherein the beamforming unit is one of (i) a Minimum Variance Distortionless Response beamformer, or (ii) a Linearly Constrained Minimum Variance beamformer.

17. The system according to claim 14, wherein the estimation filtering unit further comprising:
an adaptive foreground filter that adaptively estimates the early reflections signal;
a fixed background filter that stores the last stable setting of the adaptive foreground filter; and
a filter control unit that controls a adaptation rate of the adaptive foreground filter and selects the smaller residual error output between the adaptive foreground filter and the fixed background filter.

18. The system according to claim 14, wherein the late reflections signal is a linear combination of a plurality of early reflections signal.
